(19) United States
(12) Patent Application Publication
(10) Pub. No.: US 2005/0082009 A1
(43) Pub. Date: Apr. 21, 2005

(54) Film transfer device

(76) Inventor: Kojiro Yamashita, Saltama (JP)

Correspondence Address: WILLIAM B. PATTERSON;MOSER, PATTERSON & SHERIDAN, L.L.P., Suite 1500, 3040 Post Oak Blvd., Houston, TX, 77056, US

(21) Appl. No.: 10/827,487

(22) Filed: Apr. 19, 2004

(30) Foreign Application Priority Data
Oct. 21, 2003 (JP) 2003-360793

(51) Int. Cl. B32B 31/00; B44C 1/00

(52) U.S. Cl. 156/540; 156/577; 156/574

(57) ABSTRACT

The present invention further improves conventional film transfer devices to provide a film transfer device that can be more conveniently used. The film transfer device comprises a case containing two film transfer sets. The sets mainly include delivery reels, respectively, around which corresponding transfer tapes having films on substrate tapes are wound and which deliver the corresponding transfer tapes for use, transfer heads respectively, each of which presses the corresponding transfer tape against a film-transferred surface to transfer the film to the surface, and windup reels, respectively, around which the corresponding tapes after transfer are wound up. The transfer tapes include films for corrections which have different widths. Either of the transfer tapes can be properly selected depending on the film-transferred area.

### CROSS-REFERENCE TO RELATED APPLICATIONS

This application claims benefit of Japanese patent application serial number JP 2003-360793, filed Oct. 21, 2003, which is herein incorporated by reference.

### BACKGROUND OF THE INVENTION

1. Field of the Invention

The present invention relates to a film transfer device that transfers a transfer tape including an arbitrary film to a film-transferred surface, the film being used for corrections, adhesions, markers (highlighters) and the like.

2. Description of the Related Art

To correct wrong characters during writing, a known type of a correction device applies a white-out. However, such a liquid applying type correction device requires a long time to dry a coating liquid. Disadvantageously, it is thus impossible to immediately write correct characters on the corrected area.

To solve this problem, a type of a film transfer device has been available which transfers a transfer tape including an arbitrary film to a film-transferred surface. Various shapes and structures have been proposed for this type (for example, Japanese Patent Laid-Open No. 2000-59692, Japanese Patent Laid-Open No. 10-119489, Japanese Design Publication No. 1059863, Japanese Design Publication No. 1085305, and Japanese Design Publication No. 1089536).

Moreover, film transfer devices have also been proposed which are integrated with writing implements such as a pen which are likely to be used simultaneously with the film transfer device (for example, Japanese Patent Laid-Open No. 10-25056 and National Publication of International Patent Application No. 2003-511265).

### SUMMARY OF THE INVENTION

It is an object of the present invention to further improve conventional film transfer devices to provide a film transfer device that can be more conveniently used.

To accomplish this object, a film transfer device according to the present invention comprises a plurality of film transfer sets each comprising a delivery section for delivering a transfer tape with a film on a substrate tape, a transfer head for pressing the transfer tape against a film-transferred surface to transfer the film, and a windup section for winding up the transfer tape after transfer. The films from the transfer tapes of the plurality of sets can be selectively transferred to the film-transferred surface.

The transfer heads of the film transfer sets can be arranged at respective ends of a film transfer device main body.

The plurality of film transfer sets can be arranged side by side substantially along an imaginary line joining the opposite ends of the film transfer device main body together.

The plurality of film transfer sets can be disposed so as to overlap each other in a direction perpendicular to an imaginary line joining the opposite ends of the film transfer device main body together.

The plurality of film transfer sets can be arranged so that reels of the different film transfer sets are adjacent to each other.

The plurality of film transfer sets can be arranged in parallel along a direction perpendicular to an imaginary line joining the opposite ends of the film transfer device main body together.

According to the present invention, various films different in side, color, and kind which vary with the film transfer sets can be transferred to a film-transferred surface by delivering transfer tapes with films and winding up the transfer tapes after transfer.

In the prior art, a film transfer devices comprise only one type of film. Accordingly, for a film-transferred area, a film has to be used even if it does not fit this area in size. For example, if a wide film is to be transferred to a part of writing having small spaces between lines, it is impossible to prevent the film from covering over the upper and lower adjacent lines. Similarly, it is impossible to prevent the adhesion film from sticking out from an area to be transferred to an undesirable area.

However, according to the present invention, when for example, transfer tapes with films having different widths are assigned to the respective sets, a film fitting a film-transferred area in size can be selected and transferred by pressing a transfer tape of a width fitting the film-transferred area, against the film-transferred area, using the transfer heads of the set to which this transfer tape is assigned. This provides a film transfer device that can be more conveniently used.

Alternatively, when for example, transfer tapes with films having different colors are assigned to the respective sets, a film matching a film-transferred area in color can be selected and transferred by pressing a transfer tape with a color matching the film-transferred area, against the film-transferred area, using the transfer heads of the set to which this transfer tape is assigned.

Moreover, if each set comprises transfer tapes with films having the same attributes, the film transfer device can be used for a period of time equal to a multiple of the period of time for which a single set can be used, the multiple being equal to the number of the sets.

This provides a film transfer device that can be more conveniently used.

An example of a combination of transfer tapes assigned to the respective sets includes a combination of transfer tapes of the same type having different widths or colors or a combination of different types of transfer tapes (for example, transfer tapes for corrections and adhesions, or transfer tapes for corrections and markers (highlighters)). It will be obvious from the spirits of the present invention that the term “direction perpendicular to an imaginary line joining opposite ends of a film transfer device main body” contained in the claims and specification means that the direction crosses the imaginary line at angles of about 90° and does not mean that the angles between the direction and the imaginary line are not strictly limited to 90°.

The present disclosure relates to subject manner contained in Japanese Patent Application No. 2003-360793, filed on Oct. 21, 2003, which is expressly incorporated herein by reference in its entirety.

### BRIEF DESCRIPTION OF THE DRAWINGS

FIG. 1 is a front view representing a film transfer device according to a first embodiment of the present invention;

FIG. 2 is a sectional view representing the internal structure of the device in FIG. 1;

FIG. 3 is a sectional view representing the internal structure of the device in FIG. 1 as seen from its bottom;

FIG. 4 is a sectional view representing the internal structure of a film transfer device according to a second embodiment of the present invention;

FIG. 5 is a sectional view representing the internal structure of the device in FIG. 4 as seen from its bottom;

FIG. 6 is a sectional view representing the internal structure of a film transfer device according to a third embodiment of the present invention;

FIG. 7 is a sectional view representing the internal structure of a film transfer device according to a fourth embodiment of the present invention;

FIG. 8 is a sectional view representing the internal structure of a film transfer device according to a fifth embodiment of the present invention; and

FIG. 9 is a sectional view representing the internal structure of the device in FIG. 8 as seen from its bottom.

### DETAILED DESCRIPTION

Embodiments of the present invention will be described below with reference to the drawings.

### FIRST EMBODIMENT

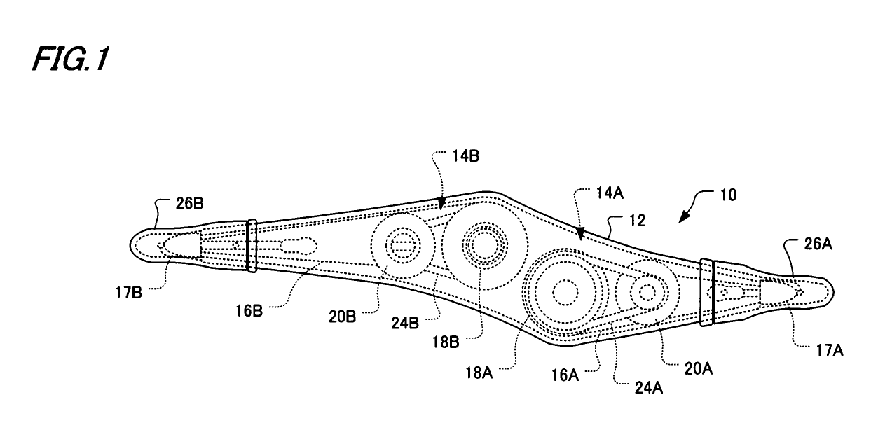

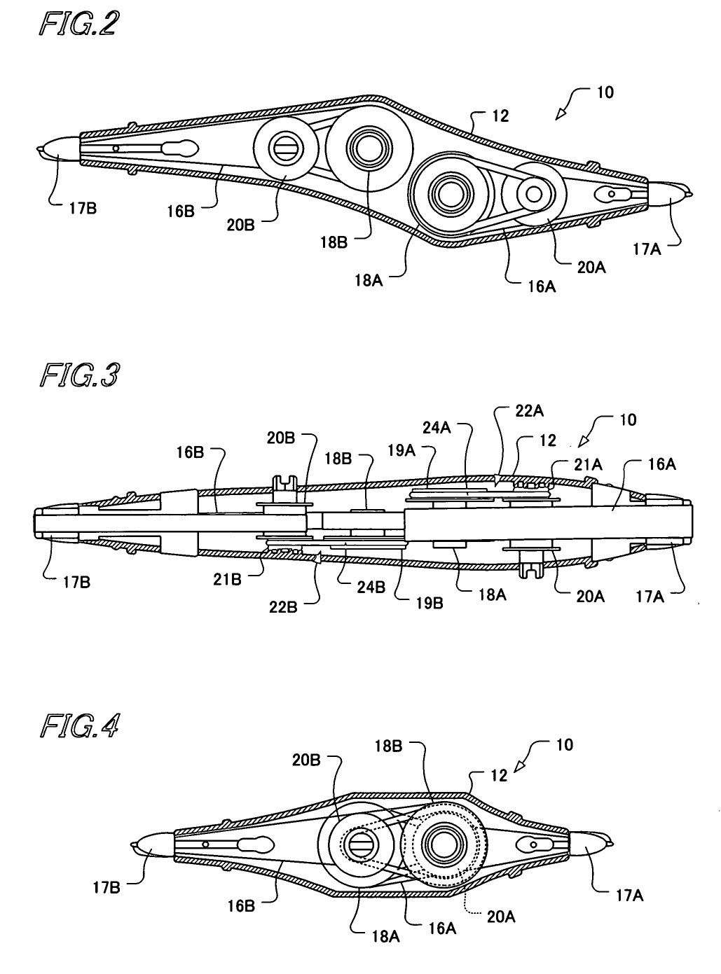

FIGS. 1 to 3 are diagrams representing a film transfer device according to a first embodiment of the present invention. As shown in the figures, this film transfer device 10 comprises a case 12 constituting a film transfer device main body and containing two film transfer sets 14A and 14B. The sets 14A and 14B mainly comprise delivery reels (delivery sections) 18A and 18B, respectively, around which corresponding transfer tapes including a coating film and substrate tape are wound and which deliver the corresponding transfer tapes 16A and 16B for use, transfer heads 17A and 17B, respectively, each of which presses the corresponding transfer tape 16A or 16B against a film-transferred surface to transfer the film to the surface, and windup reels (windup sections) 20A and 20B, respectively, around which the corresponding tapes 16A and 16B after transfer are wound up. To enable the delivery reels 18A and 18B and the windup reels 20A and 20B to be rotated, respective boss portions are pivoted on the case 12. A rotation transmitting mechanism 22A is provided between the delivery reel 18A and the windup reel 20A to rotate these reels in unison. A rotation transmitting mechanism 22B is provided between the delivery reel 18B and the windup reel 20B to rotate these reels in unison. In this example, the rotation transmitting mechanism 22A is composed of an endless rubber belt 24A extended between a pulley portion 19A and a pulley portion 21A formed integrally with the delivery reel 18A and the windup reel 20A, respectively. The rotation transmitting mechanism 22B is composed of an endless rubber belt 24B extended between a pulley portion 19B and a pulley portion 21B formed integrally with the delivery reel 18B and the windup reel 20B, respectively. The rubber belts 24A and 24B serve to transmit the rotating forces of the delivery reels 18A and 18B generated in an unwinding direction to generate the rotating forces of the windup reels 20A and 20B in a winding direction with allowing slippage. The rotation transmitting mechanisms 22A and 22B can each be composed of a gear and a slip mechanism as is well known in the prior art.

In this example, the case 12 is elongate and streamlined and has a concave bottom surface so as to be easily held by a user. The case 12 is preferably transparent so that the amounts of transfer tapes 16A and 16B remaining can be externally determined.

The transfer heads 17A and 17B are pivoted on the case 12 and each have a tip projecting out of the corresponding end of the case 12. That is, the transfer heads 17A and 17B are shaped like strips so as to be flexed around the respective pivoted portions. Of course, the transfer heads 17A and 17B are not limited to such a strip type but may be of a roller type. Furthermore, caps 26A and 26B may be provided at the respective ends of the case 12 in order to protect the projecting transfer heads 17A and 17B while they are not used.

In this example, the transfer tapes 16A and 16B comprise coating films for corrections which have different widths.

When the film transfer device 10 configured as described above is used, one of the transfer heads 17A and 17B, projecting out of the case 12, is properly selected. If a large area is to be corrected, the transfer head 17A is pressed against the film-transferred surface to transfer the transfer tape 16A. On the other hand, if a small area is to be corrected, the transfer head 17B can be pressed against the film-transferred surface to transfer the transfer tape 16B. This enables the transfer of a film fitting the area to be corrected. Therefore, the film transfer device can be more conveniently used.

### SECOND EMBODIMENT

FIGS. 4 and 5 are drawings representing a film transfer device according to a second embodiment of the present invention. Parts similar to those of the above embodiment are denoted by the same reference numerals.

The second embodiment is the same as the first embodiment in that the two film transfer sets 14A and 14B are provided in the case 12 of the film transfer device 10. However, the second embodiment is different from the first embodiment in the following point. In the first embodiment, the film transfer sets 14A and 14B are provided side by side along the line extending along the longitudinal direction of the case 12 which line joins the opposite ends of the case 12 together. However, in this embodiment, the film transfer sets 14A and 14B are disposed so as to overlap each other in a direction perpendicular to the line extending along the longitudinal direction of the case 12 which line joins the opposite ends of the case 12 together. Accordingly, the bosses of the delivery reel 18A and windup reel 20B of the sets 14A and 14B, respectively, are coaxially fitted on each other so as to be relatively rotatable. These reels are each supported on the case 12. Likewise, the bosses of the windup reel 20A and delivery reel 18B are coaxially fitted on each other so as to be relatively rotatable. These bosses are each pivoted on the case 12.

The film transfer device configured as described above can perform similar operations. In this example, the film transfer sets 14A and 14B overlap each other, thus enabling a reduction in the length between the opposite ends of the case 12.

### THIRD EMBODIMENT

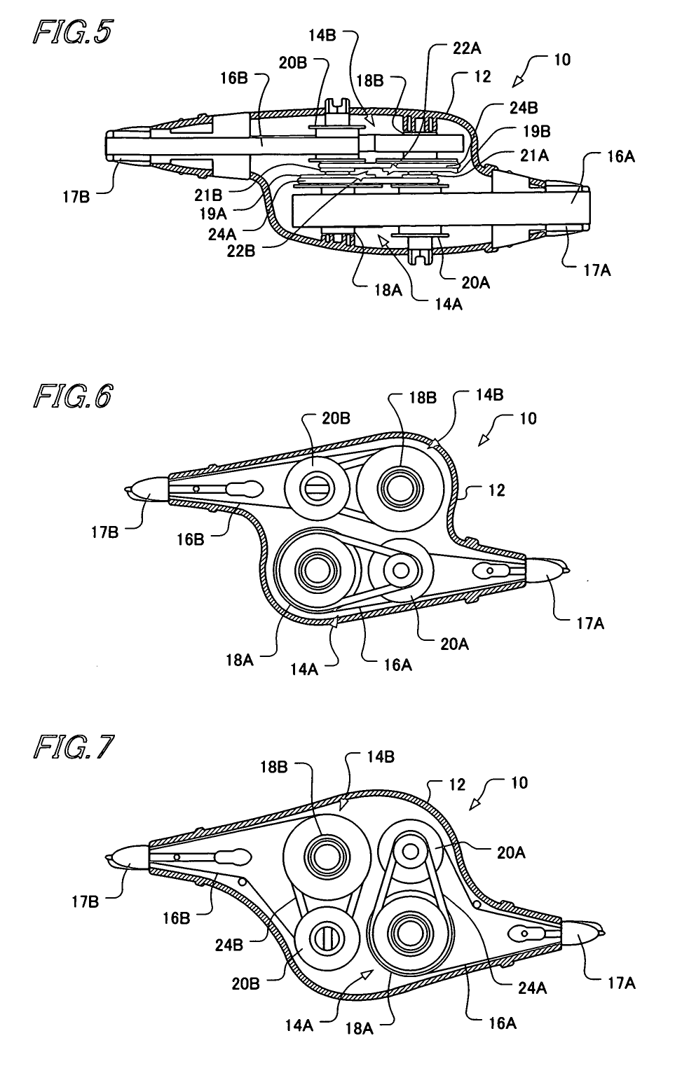

FIG. 6 is a drawing representing a film transfer device according to a third embodiment of the present invention. Parts similar to those of the above embodiment are denoted by the same reference numerals.

The third embodiment is the same as the first embodiment in that the two film transfer sets 14A and 14B are provided in the case 12 of the film transfer device 10. However, the third embodiment is different from the first embodiment in the following point. In the first embodiment, the film transfer sets 14A and 14B are provided side by side along the line extending along the longitudinal direction of the case 12 which line joins the opposite ends of the case 12 together. However, in this embodiment, the film transfer sets 14A and 14B are arranged side by side along a direction perpendicular to the line extending along the longitudinal direction of the case 12 which line joins the opposite ends of the case 12 together.

The film transfer device configured as described above can perform similar operations. In this example, it is also possible to reduce the length between the opposite ends of the case 12.

### FOURTH EMBODIMENT

FIG. 7 is a drawing representing a film transfer device according to a fourth embodiment of the present invention. Parts similar to those of the above embodiment are denoted by the same reference numerals.

The fourth embodiment is the same as the first embodiment in that the two film transfer sets 14A and 14B are provided in the case 12 of the film transfer device 10 and in that the film transfer sets 14A and 14B are provided side by side along a line extending along the longitudinal direction of the case 12 which line joins the opposite ends of the case 12 together. However, the fourth embodiment is different from the first embodiment in the following point. In the first embodiment, the delivery reels 18A and 18B and windup reels 20A and 20B of the sets 14A and 14B, respectively, are arranged side by side along the longitudinal direction of the case 12. However, in this embodiment, the delivery reels 18A and 18B and windup reels 20A and 20B of the sets 14A and 14B, respectively, are arranged side by side along a direction perpendicular to the line extending along the longitudinal direction of the case 12 which line joins the opposite ends of the case 12 together.

The film transfer device configured as described above can perform similar operations. In this example, it is also possible to reduce the length between the opposite ends of the case 12.

### FIFTH EMBODIMENT

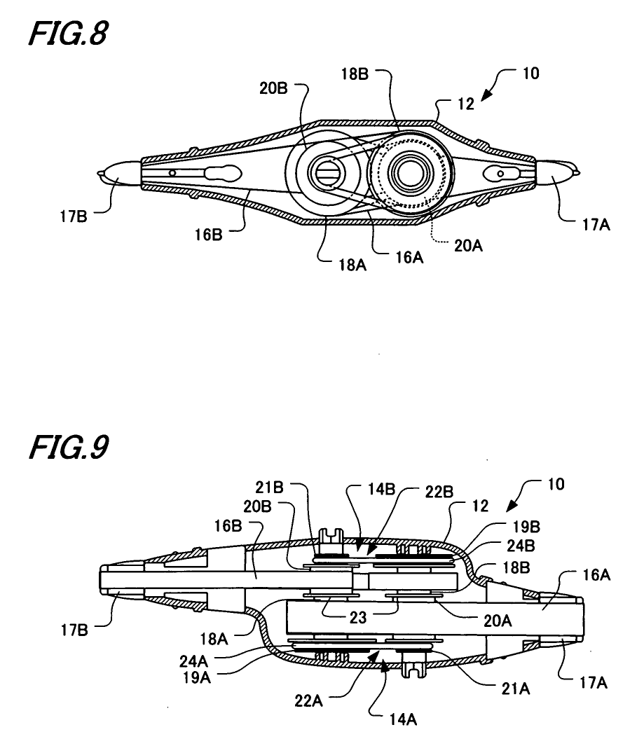

FIGS. 8 and 9 are drawings representing a film transfer device according to a fifth embodiment of the present invention. Parts similar to those of the above embodiment are denoted by the same reference numerals. This embodiment is similar to the second embodiment but differs from it in the following point. In the second embodiment, the film transfer sets 14A and 14B are overlapped with each other in a manner that the rotation transmitting mechanisms 22A and 22B of the film transfer sets 14A and 14B, respectively, are arranged inside, whereas the reels 18 (18A and 18B) and 20 (20A and 20B) are arranged outside. However, in this embodiment, the film transfer sets 14A and 14B are overlapped with each other in a manner that, the rotation transmitting mechanisms 22A and 22B of the film transfer sets 14A and 14B, respectively, are arranged outside, whereas the reels 18 (18A and 18B) and 20 (20A and 20B) are arranged inside. In this case, the delivery reel 18A and windup reel 20B of the film transfer sets 14A and 14B, respectively, are adjacent to each other, while the delivery reel 18B and windup reel 20A are adjacent to each other. Thus, each pair of the reels can only be partitioned by, for example, a common partition plate 23. This enables the thickness of the case 12 to be reduced. Similarly, the bosses of the delivery reel 18A and windup reel 20B of the sets 14A and 14B, respectively, are coaxially fitted on each other so as to be relatively rotatable, with the bosses each pivoted on the case 12 and in that the bosses of the windup reel 20A and delivery reel 18B are coaxially fitted on each other so as to be relatively rotatable, with the bosses each pivoted on the case 12.

In the above examples, the films of the transfer tapes 16A and 16B of the film transfer sets 14A and 14B have different widths. However, the present invention is not limited to this aspect. It is possible to combine films in different colors or of different types (for example, films for corrections and adhesions, or films for corrections and markers (highlighters)). Accordingly, a single film transfer device can be conveniently used for various purposes.

In the above embodiments, the case 12, constituting the film transfer device main body, is composed of a single member, however, the present invention is not limited to this aspect. The case 12 may be composed of a plurality of members. Moreover, an at least partial partition plate may be properly provided between the plurality of sets in order to prevent the sets from interfering with each other. Furthermore, in the above embodiments, the film transfer device is intended to be disposal, however, the present invention is not limited to this aspect. The film transfer device can be configured so that the film transfer set 14A or 14B can be properly removed from the case 12 for replacement.

In the above embodiments, the transfer heads 17A and 17B are arranged at the opposite ends of the case 12, that is, at substantially opposite positions around the periphery of the case 12, however, the present invention is not limited to this aspect. The transfer heads 17A and 17B may be arranged at any positions around the periphery of the case 12 so as not to lie opposite each other. In this case, the transfer heads 17A and 17B may be suitably spaced from each other so that when one 17 of the transfer heads is used, the other will not obstruct the operation, more desirably, so that the case 12 is set to be inclined at sufficiently different angles when held to press the transfer head 17A and when held to press the transfer head 17B. Moreover, in the above embodiments, the two transfer heads 17A and 17B are provided, however, the present invention is not limited to this aspect. Three or more transfer heads may be provided. Also in this case, the plurality of transfer heads are preferably located so that the case 12 is set to be inclined at sufficiently different angles when held to press respective transfer heads.

1. A film transfer device comprising a plurality of film transfer sets each comprising a delivery section for delivering a transfer tape with a film on a substrate tape, a transfer head for pressing the transfer tape against a film-transferred surface to transfer the film, and a windup section for winding up the transfer tape after transfer, wherein the films from the transfer tapes of the plurality of sets can be selectively transferred to the film-transferred surface.

2. The film transfer device according to claim 1, further comprising a main body containing the plurality of film transfer sets wherein the transfer heads of the film transfer sets are arranged at respective ends of the main body.

3. The film transfer device according to claim 2, wherein said plurality of film transfer sets are arranged side by side substantially along an imaginary line joining the opposite ends of the main body together.

4. The film transfer device according to claim 2, wherein said plurality of film transfer sets are disposed so as to overlap each other in a direction perpendicular to an imaginary line joining the opposite ends of the main body together.

5. The film transfer device according to claim 4, wherein the plurality of film transfer sets comprises at least one reel, and said film transfer sets are arranged so that reels of the different film transfer sets are adjacent to each other.

6. The film transfer device according to claim 2, wherein said plurality of film transfer sets are arranged side by side along a direction perpendicular to an imaginary line joining the opposite ends of the film transfer device main body together.
